(19) United States
(12) Patent Application Publication
(10) Pub. No.: US 2002/0146227 A1
(43) Pub. Date: Oct. 10, 2002

(54) Collimator block for optical functional module

(76) Inventors: Makoto Suzuki, Chiba-shi (JP); Akihiro Iino, Chiba-shi (JP); Haruhiko Hasegawa, Chiba-shi (JP); Tomohiro Shimada, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/096,383

(22) Filed: Mar. 12, 2002

(30) Foreign Application Priority Data
Mar. 28, 2001 (JP) 2001-093836

(51) Int. Cl. G02B 6/00; G02B 6/32

(52) U.S. Cl. 385/134; 385/33

(57) ABSTRACT

An optical functional module collimator block capable of easily adjusting the position and/or direction of collimators opposed to each other and capable of correcting an error in the position or direction. The collimator module has an adjusting device for optical axis alignment between two collimators held by holding members on a base member in a state of being opposed to each other. The adjusting device includes fixing screws for fixing at least one of the holding members on the base member, and adjusting screws for adjusting the position and/or direction of the holding member.

### BACKGROUND OF THE INVENTION

1. Field of the Invention

The present invention relates to an optical functional module collimator block on which is mounted an optical functional device such as an attenuator device, a shutter device, or a switching device for attenuating or interrupting an optical signal used in optical communication or the like, or for switching between paths for optical signals.

2. Description of the Related Art

In an optical network using optical fibers and used for the Internet or the like, there is a need to perform attenuation or interruption of optical signals, switching of signal paths, etc., in a repeater. Various optical functional components such as attenuators, shutter devices and switching devices having corresponding functions are therefore used.

There is a demand that these optical functional parts be miniaturized into a module to thereby miniaturize the relaying equipment.

To modularize the above-mentioned optical functional components, an optical functional module collimator block using collimators is commonly employed.

FIGS. 5A and 5B show a conventional optical functional module collimator block 200. FIG. 5A is a plan view showing a conventional collimator block 200, and FIG. 5B is a front view of the conventional collimator block 200.

The conventional optical functional module collimator block 200 is constituted by collimators 101 and 101′ and a holding member 203 placed on a base member 204 to hold the collimators 101 and 101′ in an opposed state. Optical cables 102 and 102′ are respectively connected to the collimators 101 and 101′.

An optical signal supplied through the optical capable 102 is transmitted as a bundle of parallel rays from the collimator 101 to the collimator 101′ opposed to the collimator 101. A beam 106 is thereby formed in the space between the opposed collimators 101 and 101′.

An optical functional component 205 is placed so as to contain the path for the beam 106. The optical functional component 205 is thereby enabled to perform its function. If three or more collimators are provided and held by the holding member 203, and if a switching device is used as the optical functional component 205, the function of switching between optical signal paths can be performed.

In the conventional optical functional module collimator block, it is important to position the opposed collimators for optical axis alignment.

The diameter of the beam is, for example, 500 μm. Even a small displacement in position or direction of one of the collimators from the optical axis impairs the function of the optical functional module collimator block. To prevent such a displacement, high-precision working of the holding member is required at the manufacturing stage. That is, it is necessary to precisely work the holding member so as to prevent an occurrence of an error in shape of the holding member and errors in size, shape, position and angle of the hole in which each collimator is inserted. Such working is considerably burdensome to a manufacturer in terms of cost and working efficiency.

The collimators are inserted into the holes formed in the holding member, correctly adjusted in position and in direction, and are mounted on the holding member by welding or bonding with an adhesive while being maintained in the adjusted state.

In the case of mount by welding, however, it is difficult to perform welding while maintaining the collimators in suitable positions and at suitable heights for a long time. There is also a fear of the holding member being expanded and contracted by heat generated during welding to cause an error in position or direction of the collimators. Also, the welding area is restricted to prevent the collimators from being damaged by heat, and there is a fear of an occurrence of an error due to lack of bonding strength resulting from the restriction.

Mount by bonding with an adhesive is free from the above-described problems due to heat generated during welding, but is more burdensome on a manufacturer since it requires a procedure for prevention of errors in which each collimator is held in a suitable positions and direction for a long time until the adhesive is completely dried.

Further, in the conventional art, all the collimators are fixed to the same holding member fixed on the base member. In the case of an occurrence of an error problem, a functional problem or any other problem with the collimators, there is a need to remove all the collimators from the holding member even if the problem relates to only one of the collimators. Thus, there is also a problem in terms of cost and maintainability.

### SUMMARY OF THE INVENTION

In view of the above-described problems of the conventional art, an object of the present invention is to provide an optical functional module collimator block capable of adjusting the position and/or direction of one of at least two collimators when an error occurs in the position or direction.

Aspects of the present invention will be described hereinbelow.

According to a first aspect of the present invention, there is provided a collimator block for an optical functional module, including: a base member; at least two holding members for holding collimators disposed on the base member; at least two collimators held by the holding members in a state of being opposed to each other; and adjustment means capable of adjusting one of the position and direction of at least one of the collimators to perform optical axis alignment between the collimators.

According to a second aspect of the present invention, in the first aspect of the invention, there is provided a collimator block for an optical functional module, in which one of the position and direction of at least one of the holding members can be adjusted by the adjustment means.

According to a third aspect of the present invention, in the first or second aspect of the invention, there is provided a collimator block for an optical functional module, in which the adjustment means includes a plurality of fixing screws for fixing the holding members on the metallic base member, and a plurality of adjusting screws for adjusting one of the position and direction of the holding member.

According to a fourth aspect of the present invention, in the third aspect of the invention, there is provided a collimator block for an optical functional module, in which the fixing screws correspond to through holes formed through the base member from its back side to its side, and to threaded holes formed in the holding member, the fixing screws being screwed into the threaded holes to fix the holding member on the base member.

According to a fifth aspect of the present invention, in the third or fourth aspect of the invention, there is provided a collimator block for an optical functional module, in which the adjusting screws correspond to a plurality of threaded holes formed through the base member from its back side to its front side, and the height and direction of the holding member are adjusted based on an inclination of the surface of the holding member in contact with the adjusting screws caused by differences in depths through which the respective adjusting screws are threaded into the threaded holes.

According to a sixth aspect of the present invention, in any one of the first to fifth aspects of the invention, there is provided a collimator block for an optical functional module, in which at least one of the holding members is inserted in a channel formed in an end portion of the base member.

According to a seventh aspect of the present invention, in the first or second aspect of the invention, there is provided a collimator block for an optical functional module, in which at least one of the holding members is inserted in a wall portion provided on an end portion of the base member; the adjustment means includes a plurality of insertion holes each formed through the wall portion from its outer surface to the holding member, and a plurality of pressing members each extending from the outer surface of the wall portion to the holding member; and one of the position and direction of the holding member is adjusted through pressing forces of each of the pressing members to achieve optical axis alignment between the collimators.

According to an eighth aspect of the present invention, in the seventh aspect of the invention, there is provided a collimator block for an optical functional module, in which the pressing force of each of the pressing members exerted on the holding member can be adjusted by changing the length of the pressing members by fixing means including a screw.

According to a ninth aspect of the present invention, in any one of the first to eighth aspects of the invention, there is provided a collimator block for an optical functional module, in which each of the holding member, the base member, and the adjustment means is made of stainless steel.

According to a tenth aspect of the present invention, in any one of the first to ninth aspects of the invention, there is provided a collimator block for an optical functional module, in which each of the holding member, the base member, and the adjustment means is made of a super engineering plastic.

### BRIEF DESCRIPTION OF THE DRAWINGS

FIG. 1A is a plan view of an optical functional module collimator block 100 which represents a first embodiment of the present invention;

FIG. 1B is a front view of the collimator block 100 shown in FIG. 1A;

FIG. 1C is a sectional side view of the collimator block 100 taken along the line A-A′ in FIG. 1A;

FIGS. 2A and 2B are diagrams showing a method of adjusting the position of a holding member 103;

FIGS. 2C and 2D are diagrams showing a method of adjusting the direction of the holding member 103;

FIG. 3A is a plan view of an optical functional module collimator block 100 which represents a second embodiment of the present invention;

FIG. 3B is a front view of the collimator block 100 shown in FIG. 3A;

FIG. 3C is a sectional side view of the collimator block 100 taken along the line B-B′ in FIG. 3A;

FIG. 4A is a plan view of an optical functional module collimator block 100 which represents a third embodiment of the present invention;

FIG. 4B is a sectional side view of the collimator block 100 taken along the line C-C′ in FIG. 4A;

FIG. 5A is a plan view of a conventional optical functional module collimator block 200; and

FIG. 5B is a front view of the conventional optical functional module collimator block 200.

### DESCRIPTION OF THE PREFERRED EMBODIMENTS

An optical functional module collimator block in accordance with the present invention will be described with reference to the accompanying drawings. The following description of embodiments of the present invention is made only for the purpose of illustration and is not be construed as a limitation to the scope of the invention. Various modifications of the embodiments of the invention including some or all of the components are conceivable by those skilled in the art. Such modifications also fall within the scope of the invention.

(First Embodiment)

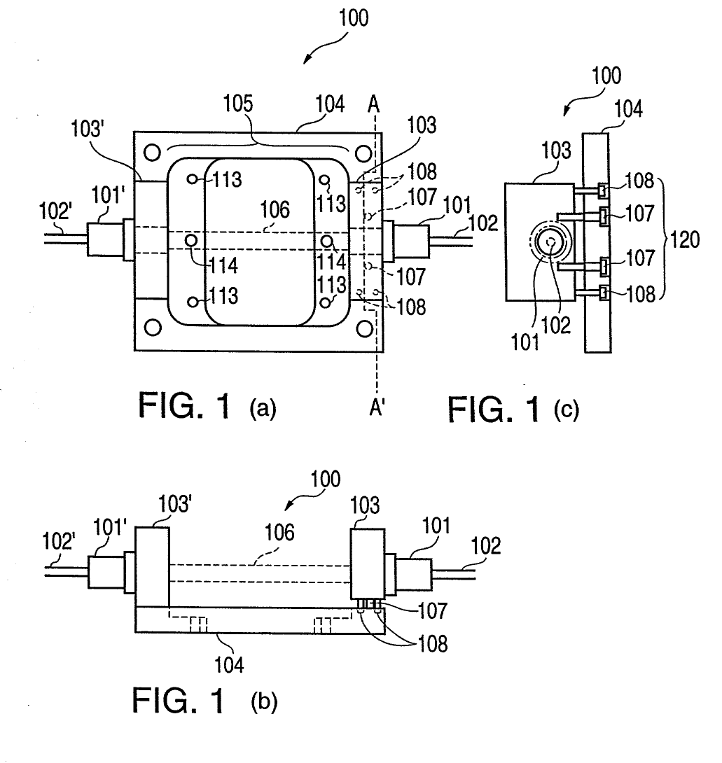

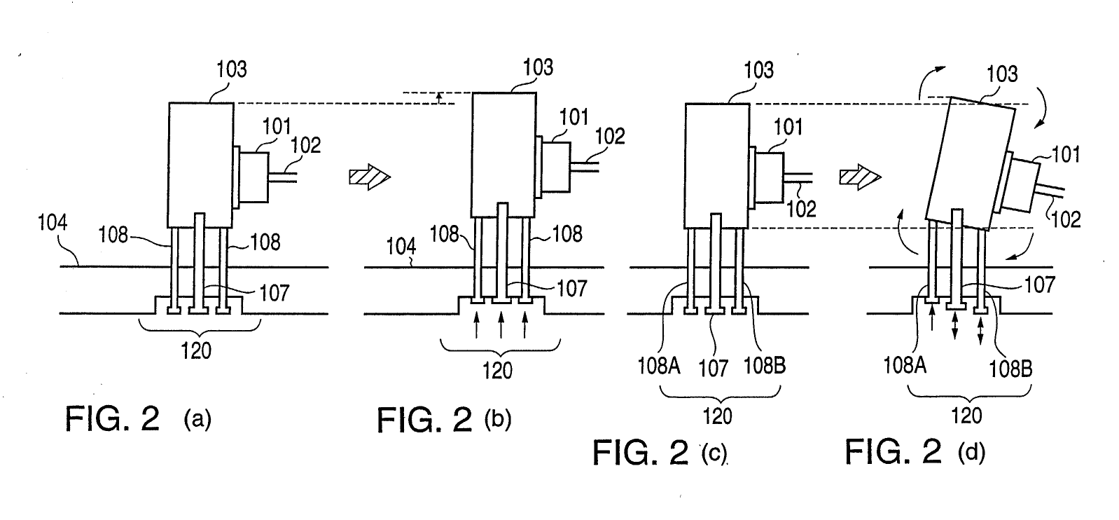

An optical functional module collimator block 100 which represents a first embodiment of the present invention will be described with reference to FIGS. 1 and 2.

The optical functional module collimator block 100 is constituted by holding members 103 and 103′ disposed on a base member 104 to respectively hold collimators 101 and 101′, an optical cable 102 connected to the collimator 101, an optical cable 102′ connected to the collimator 101′, and adjustment member 120 for fixing the holding member 103 on the base member 104.

The adjustment member 120 is constituted by fixing screws 107, adjusting screws 108 for adjustment of the position and direction of the holding member 103, and an optical functional component mount 105 on which an optical functional component (not shown) such as an attenuator, a shutter device or a switching device is placed.

The optical functional component mount 105 is formed as a recess in the metallic base member 104 and includes threaded holes 113 and guide pins 114 for fixing the optical functional component.

Preferably, stainless steel, e.g., one selected from SUS304, 312, 316, and so on is used as the material of the holding members 103 and 103′, the base member 104, the fixing screws 107 and the adjusting screws 108 to prevent formation of rust during a long period.

A super engineering plastic may be used as the material of the holding members 103 and 103′, the base member 104, the fixing screws 107 and the adjusting screws 108 in order to limit the amount of thermal expansion.

Super engineering plastics have a thermal expansion coefficient of smaller than that of conventional engineering plastics and the extent of expansion of super engineering plastics caused by heat is small. The thermal expansion coefficient of polyetheretherketone (PEEK), which is one of typical super engineering plastics, is 2.3×10⁻⁵/K at 200° C., smaller than 2.7×10⁻⁵/K of polycarbonate (PC), which is one of the conventional engineering plastics.

An optical signal supplied through the optical capable 102 is transmitted as a bundle of parallel rays from the collimator 101 to the collimator 101′ opposed to the collimator 101. A beam 106 is thereby formed in the space between the opposed collimators 101 and 101′.

An optical functional component (not shown) is placed on the optical functional component mount 105 so as to contain the path for the beam 106. The optical functional component is thereby enabled to perform its function.

The arrangement may be such that three or more collimators are provided on the base member 104, two or more collimators are disposed at positions opposite from one collimator, and a switching device using refraction of light is used as an optical functional component, thereby enabling switching between optical signal paths. Further, a plurality of collimators may be disposed at positions such as to be opposed to another plurality of collimators. For example, three collimators are disposed at positions such as to be opposed to two collimators.

The holding member 103 on which the collimator 101 is mounted is mounted on the base member 104 with the fixing screws 107 as an adjustment portion, as shown in FIGS. 1B and 1C.

Each fixing screw 107 has a fine strong thread. The base member 104 has corresponding through holes formed therethrough between its front and back surfaces. The holding member 103 has threaded holes corresponding to the fixing screws 107. Joining of the holding member with the screws 107 includes a “temporary fixing” function, whereby the efficiency and facility with which mounting and adjusting operations are performed after joining of the holding member are improved.

The adjusting screws 108 also have a fine strong thread similar to that of the screws 107. The base member 104 has corresponding female threads formed therethrough between its front and back surfaces. When one of the adjusting screws 108 is turned for screwing into the female thread, it acts as a “push screw” by exerting an upward force from the base member 104 to push upward the holding member.

Therefore each screw 107 acts as a “pull screw” to pull back the holding member 103 toward the base member 104 by a force produced as reaction to the force of the adjusting screws 108.

By the interaction of the forces of the fixing screws 107 and the adjusting screws 108 in different directions, the holding member 103 and the base member 104 can be fastened to each other more firmly. A backlash prevention effect can also be obtained by using the interaction, thereby enabling prevention of loosening of the fixing screws 107 and the adjusting screws 108 and maintenance of the fastened state over a long time period.

The fixing screws 107 and the adjusting screws 108 having the function of fixing the holding member 103 on the base member 1 also function as adjustment member in such a manner that when an error in position or direction of the collimator 101 or 101′ results in optical axis misalignment between the collimators 101 and 101′, which are opposed to each other, the fixing screws 107 and the adjusting screws 108 are operated to align the optical axes of the collimators 101 and 101′ by adjusting the position and the direction of the holding member 103 on which the collimator 101 is mounted, and to maintain the adjusted position and direction.

FIGS. 2A and 2B are diagrams showing the method of adjusting the position of the holding member 103. When there is a need to move the collimator 101 upward, all the fixing screws 107 and the adjusting screws 108 are turned for screwing into the threaded holes through the same distance, thereby shifting the collimator 101 upward.

FIGS. 2C and 2D are diagrams showing the method of adjusting the direction of the holding member 103. When there is a need to make the collimator 101 face upward, the adjusting screws 108A are turned for screwing into the threaded holes, the adjusting screws 108B are turned for unscrewing, and the fixing screws 107 are adjusted in relation to the operations of the adjusting screws, thereby making the collimator 101 face upward.

Through the interaction of the forces of the fixing screws 107 and the adjusting screws 108 in different directions, the adjusted position of the holding member 103 can be maintained with improved reliability over a long time period.

(Second Embodiment)

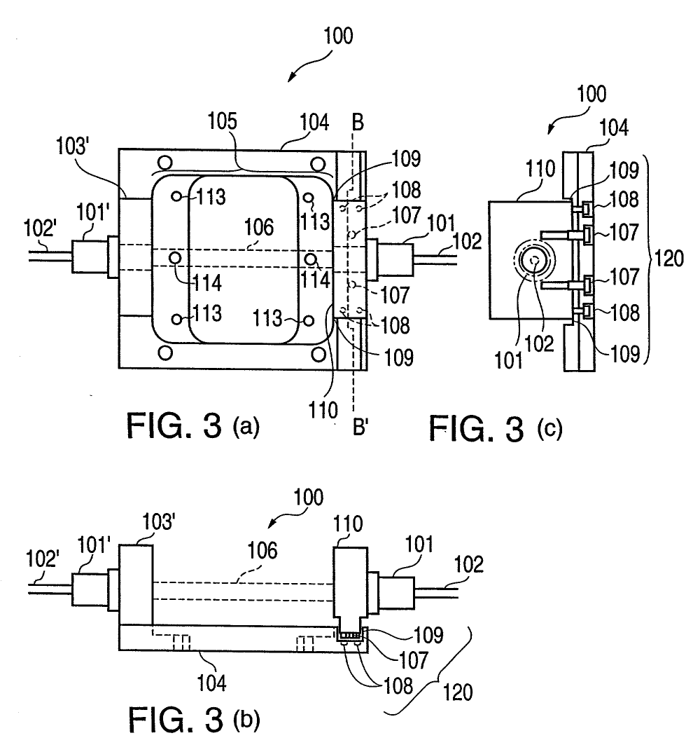

FIGS. 3A, and 3B are a plan view and a front view, respectively, of an optical functional module collimator block 100 which represents a second embodiment of the present invention, and FIG. 3C is a sectional side view taken along the line B-B′ in FIG. 3A.

The optical functional module collimator block 100 of the second embodiment of the present invention is characterized by a modification made in the first embodiment.

The modification comprises forming a channel 109 in the base member 104 and replacing the holding member 103 in the first embodiment (FIGS. 1A, 1B, and 1C) with a holding member 110 having an insertion portion fitted to the channel 109.

The channel 109 and the insertion portion of the holding member 110 are adjusted in advance to have such an amount of play therebetween that direction adjustment can be performed when the insertion portion is inserted in the channel 109.

The holding member 110 is inserted into the channel 109 to be stabilized. The holding member 110 is thereby prevented from falling at the time of each of mounting, position adjustment, and direction adjustment with the fixing screws 107 and the adjusting screws 108, thus improving the efficiency and facility with which the mounting or adjusting operations are performed.

The shapes, functions, effects, etc., of the other members are the same as those in the optical functional module collimator block 100 of the first embodiment.

(Third Embodiment)

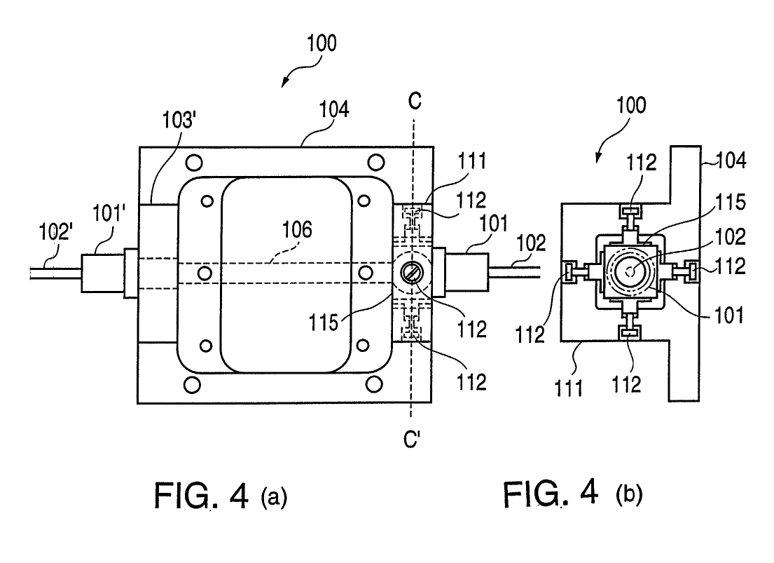

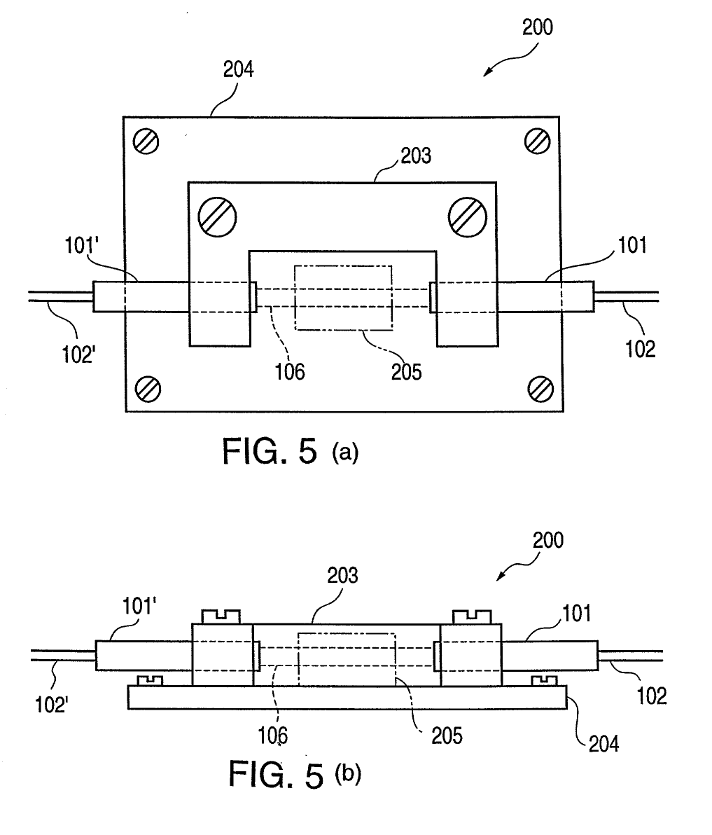

FIG. 4A is a plan view of an optical functional module collimator block 100 which represents a third embodiment of the present invention, and FIG. 4B is a sectional side view taken along the line C-C′ in FIG. 4A.

The optical functional module collimator block 100 of the third embodiment of the present invention has pressing members 112 provided as an adjustment member instead of the fixing screws 107 and the adjusting screws 108 in the first and second embodiments of the present invention.

In this embodiment, the base member 104 has a wall portion 111 projecting upwardly. A holding member 115 to which the pressing members 112 and the collimator 101 are attached is inserted in the wall portion 111 and supported on the same by means of the pressing members 112.

The holding member 115 is smaller in size than each of the holding member 103 (FIGS. 1A, 1B, and 1C) of the first embodiment and the holding member 110 (FIGS. 3A, 3B, and 3C) of the second embodiment.

The length of the screw in each pressing member 112 can be changed to enable fine adjustment of the force of pressing the holding member 115. Therefore it is possible to move the holding member 115 in all directions by adjusting the pressing forces of the pressing members 112, thus achieving the desired optical axis alignment effect.

The shapes, functions, effects, etc., of the other members are the same as those in the optical functional module collimator block 100 of the first or second embodiment.

While in each of the optical functional module collimator block 100 of the first and second embodiments the fixing screws 107 and the adjusting screws 108 stand upright on the block, the arrangement may alternatively be such that a wall portion is provided on the base member 104 at such a position so as to face the side surface of the holding member 103 shown in FIGS. 1A to 1C or the holding member 110 shown in FIGS. 3A to 3C, and the fixing screws 107 and the adjusting screws 108 are disposed so as to project horizontally from the wall portion to the side surface of the holding member 103 of 110. This arrangement (not shown) enables finer position and direction adjustment.

In each of the optical functional module collimator block 100 of the first and second embodiments, only one 103 or 110 of the holding members holding the two collimators can be adjusted in position and direction, while the opposed holding member 103′ is fixed as a wall portion on the base member and cannot be moved for adjustment. However, the present invention is not limited to this arrangement. Other adjustment member (not shown) may be provided to enable adjustment of the position and direction of all the plurality of collimators.

In the third embodiment shown in FIGS. 4A and 4B, one pressing member 112 is provided on each of the top, bottom, and two side surfaces of the holding member 115. However, this construction is not exclusively used. Two pressing members may be provided on each surface to enable direction adjustment based on the same principle as that of the method shown in FIGS. 2A to 2D.

The optical functional module collimator block 100 shown in FIGS. 4A and 4B exemplifies the case where only one of the two collimators opposed to each other is adjustable. However, the present invention is not limited to this. Other holding and pressing members 115 and 112 may be provided to enable adjustment of the position and direction of all the plurality of collimators.

According to the present invention, as described above, an optical functional module collimator block can be provided in which the position and direction of at least one of collimators opposed to each other can easily be adjusted to correct the misalignment between the optical axes of the collimators, the adjusted position and direction can be maintained with reliability over a long time period, and further adjustment can be performed if necessary.

What is claimed is:

1. A collimator block for an optical functional module, comprising:
a base member;
at least two holding members for holding collimators disposed on the base member;
at least two collimators held by the holding members in a state of being opposed to each other; and
adjustment means capable of adjusting one of the position and direction of at least one of the collimators to perform optical axis alignment between the collimators.

2. A collimator block for an optical functional module according to claim 1, wherein one of the position and direction of at least one of the holding members can be adjusted by the adjustment means.

3. A collimator block for an optical functional module according to claim 1, wherein the adjustment means includes a plurality of fixing screws for fixing the holding members on the metallic base member, and a plurality of adjusting screws for adjusting one of the position and direction of the holding member.

4. A collimator block for an optical functional module according to claim 3, wherein the fixing screws correspond to through holes formed through the base member from its back side to its front side, and to threaded holes formed in the holding member, the fixing screws being screwed into the threaded holes to fix the holding member on the base member.

5. A collimator block for an optical functional module according to claim 3, wherein the adjusting screws correspond to a plurality of threaded holes formed through the base member from its back side to its front side, and the height and direction of the holding member are adjusted based on an inclination of the surface of the holding member in contact with the adjusting screws caused by differences in depths through which the respective adjusting screws are threaded into the threaded holes.

6. A collimator block for an optical functional module according to claim 1, wherein at least one of the holding members are inserted in a channel formed in an end portion of the base member.

7. A collimator block for an optical functional module according to claim 1, wherein at least one of the holding members are inserted in a wall portion provided on an end portion of the base member; the adjustment means includes a plurality of insertion holes each formed through the wall portion from its outer surface to the holding member, and a plurality of pressing members each extending from the outer surface of the wall portion to the holding member; and one of the position and direction of the holding member is adjusted through pressing forces of each of the pressing members to achieve optical axis alignment between the collimators.

8. A collimator block for an optical functional module according to claim 7, wherein the pressing force of each of the pressing members exerted on the holding member can be adjusted by changing the length of the pressing members by fixing means including a screw.

9. A collimator block for an optical functional module according to claim 1, wherein each of the holding member, the base member, and the adjustment means is made of stainless steel.

10. A collimator block for an optical functional module according to claim 1, wherein each of the holding member, the base member, and the adjustment means is made of a super engineering plastic.
